(19) United States
(12) Patent Application Publication
(10) Pub. No.: US 2024/0152971 A1
(43) Pub. Date: May 9, 2024

(54) INFORMATION PROCESSING DEVICE, CONTENT DISPLAY SYSTEM, AND INFORMATION PROCESSING METHOD

(71) Applicant: Sharp NEC Display Solutions, Ltd., Tokyo (JP)

(72) Inventor: Yusuke OGIWARA, Tokyo (JP)

(21) Appl. No.: 18/411,679

(22) Filed: Jan. 12, 2024

Related U.S. Application Data
(63) Continuation of application No. PCT/JP2021/033887, filed on Sep. 15, 2021.

(51) Int. Cl. G06Q 30/0251

(52) U.S. Cl. CPC G06Q 30/0269

(57) ABSTRACT

An information processing device that is communicatively connected to a display device installed in a location different from a merchandise display area includes a behavior detection unit configured to detect a behavior of a person with respect to merchandise in the merchandise display area where the merchandise included in content is displayed, a generation unit configured to generate additional information according to the behavior of the person, and a display control unit configured to cause the display device to display the content and the additional information.

### TECHNICAL FIELD

The present invention relates to an information processing device, a content display system, and an information processing method.

### BACKGROUND ART

In commercial facilities such as shopping malls that have a plurality of stores, many customers shop around various stores. In recent years, digital signage using a display device has been used as a means of stimulating a purchase desire of these visitors and guiding them to purchase merchandise of each store.

Patent Document 1 describes a technology for guiding customers to a store by displaying coupon information, such as discount information for merchandise, on a display as an advertisement to encourage customers who view the information to visit the store directly.

However, even though it is possible to attract interest by displaying the advertisement for merchandise, if the merchandise is sold out when a customer goes to buy it, this may give a disappointing impression.

### CITATION LIST

### Patent Document

### [Patent Document 1]

Japanese Unexamined Patent Application, First Publication No. 2015-007863

### SUMMARY OF INVENTION

### Technical Problem

A problem to be solved is that, even though it is possible to attract interest by displaying an advertisement for merchandise on digital signage, if the merchandise is sold out when a customer goes to buy it, this may give a disappointing impression.

### Solution to Problem

According to one aspect of the present invention, an information processing device that is communicatively connected to a display device installed in a location different from a merchandise display area includes a behavior detection unit configured to detect a behavior of a person with respect to merchandise included in content in the merchandise display area where the merchandise is displayed, a generation unit configured to generate additional information according to the behavior of the person, and a display control unit configured to cause the display device to display the content and the additional information.

In addition, according to another aspect of the present invention, a content display system includes a display device installed in a location different from a merchandise display area, a behavior detection unit configured to detect a behavior of a person with respect to merchandise in content in the merchandise display area where the merchandise is displayed, a generation unit configured to generate additional information according to the behavior of the person, and a display control unit configured to cause the display device to display the content and the additional information.

Moreover, according to still another aspect of the present invention, an information processing method includes detecting a behavior of a person with respect to merchandise included in content in a merchandise display area where the merchandise is displayed, generating additional information according to the behavior of the person, and causing the display device installed in a location different from the merchandise display area to display the content and the additional information.

### Advantageous Effects of Invention

According to the present invention, it is possible to display an advertisement that further stimulates the purchase desire of a customer by making the customer impatient with a behavior of other people toward the merchandise in digital signage.

### BRIEF DESCRIPTION OF DRAWINGS

FIG. 1 is a schematic block diagram which describes a configuration of a content display system in an embodiment.

FIG. 2 is a flowchart for describing an operation of content display processing executed by the content display system.

FIG. 3 is an image diagram which shows a display example of an advertisement displayed by a display device.

FIG. 4 is an image diagram which shows a display example in which supplementary additional information is added to the advertisement displayed by the display device.

FIG. 5 is a diagram which shows a configuration of the content display system.

FIG. 6 is a diagram which shows a configuration of an information processing device.

### DESCRIPTION OF EMBODIMENTS

Hereinafter, an embodiment of the present invention will be described.

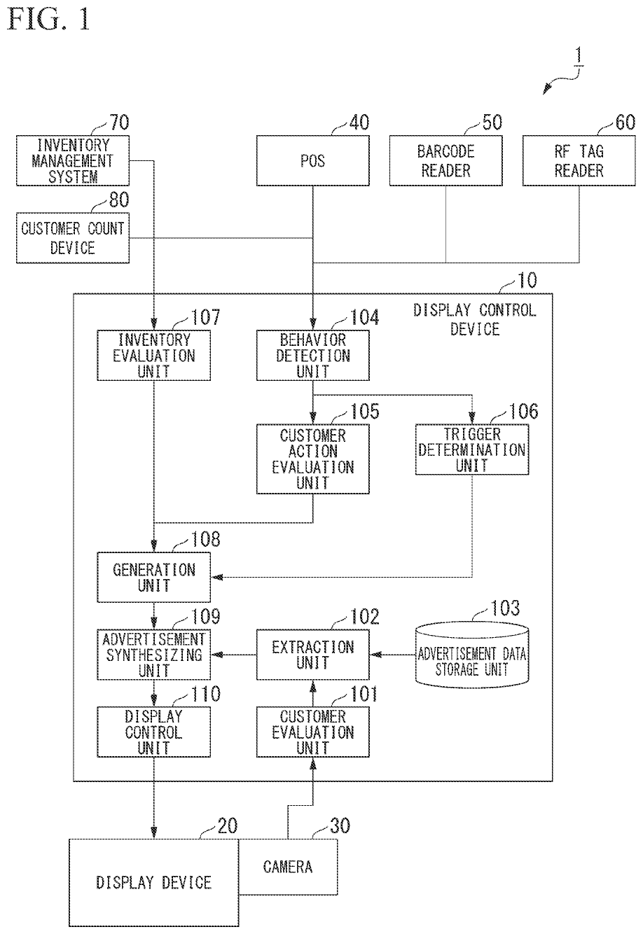

FIG. 1 is a schematic block diagram which describes a configuration of a content display system according to an embodiment of the present invention. In this embodiment, the content display system 1 is a system for display control of content to be displayed on electronic signage such as digital signage. Content is for an advertisement, and may be a still image or moving image, and may or may not have sound. In the present embodiment, in a commercial facility such as a shopping mall, digital signage that displays content of an advertisement for merchandise to be sold by each store of the commercial facility will be described as an example.

In FIG. 1, the content display system 1 includes a display control device 10, a display device 20, a camera 30, a point of sale (POS) 40, a barcode reader 50, a radio frequency (RF) tag reader 60, an inventory management system 70, and a customer count device 80.

The camera 30, the POS 40, the barcode reader 50, the RF tag reader 60, the inventory management system 70, or the customer count device 80 and the display control device 10 are connected for communication via a wired or wireless local area network (LAN). In addition, the display control device 10 and the display device 20 are connected via a video cable for transmitting video signals.

The display device 20 is digital signage that displays content for an advertisement on the display screen. The display device 20 is installed in a place different from a merchandise display area where merchandise is displayed in a commercial facility such as a shopping mall. For example, the display device 20 is installed outside the merchandise display area, such as at an entrance of a commercial facility, an entrance of each store of the commercial facility, a passage in the facility that allows movement to a store, and the like.

The merchandise display area can be any area where purchasable merchandise is displayed. The merchandise display area may be a store, or a partial area of the store (for example, an area in which a merchandise display shelf is installed, an area provided with a hanger rack in which clothes can be hung when the merchandise is clothes, an area provided with a basket for storing merchandise, and the like).

The camera 30 is installed near the display device 20, captures an image of an area near the display device 20, and generates the captured image. The nearby area may be an area in which a display screen of the display device 20 is visually recognizable.

The POS 40 is a POS register installed in each store of a commercial facility, and detects that a customer has purchased merchandise in a store. The POS 40 transmits merchandise purchase information indicating the merchandise purchased by the customer in the store in which it is installed to the display control device 10. The merchandise purchase information includes merchandise identification information for identifying the purchased merchandise and the purchase quantity.

The barcode reader 50 is installed in each store of the commercial facility and reads a barcode attached to merchandise to detect that the customer has made an inquiry about the merchandise to a store clerk in a store. For example, when a customer asks for an explanation of merchandise, the store clerk causes the barcode reader 50 to read a barcode of the merchandise. The barcode reader 50 transmits merchandise inquiry information including merchandise identification information read from the barcode to the display control device 10.

The RF tag reader 60 is installed in a predetermined reading area such as a fitting room of each store of the commercial facility, and automatically reads an RF tag attached to merchandise in the reading area to detect a trial use (try-on or try-out) of the merchandise in the store. The RF tag reader 60 transmits merchandise trial information including the merchandise identification information read from the RF tag to the display control device 10.

Although one POS 40, one barcode reader 50, and one RF tag reader 60 are shown in FIG. 1, the POS 40, the barcode reader 50, and the RF tag reader 60 are installed in each store of the commercial facility. Each store that sells merchandise included in the content of the advertisement has at least one of the POS 40, the barcode reader 50, and the RF tag reader 60. In addition, each store may have a plurality of POSs 40, barcode readers 50, or RF tag readers 60.

The inventory management system 70 is a system that manages an inventory quantity of each piece of merchandise to be sold by each store of the commercial facility. The inventory management system 70 transmits inventory quantity information of corresponding merchandise to the display control device 10 in response to an inquiry from the display control device 10.

The customer count device 80 counts the number of customers in an entirety of the commercial facility and the number of customers in each store of the commercial facility. For example, the customer count device 80 detects the number of customers by detecting entrance and exit of people using a camera installed in the commercial facility or sensors installed at a doorway of the commercial facility or each store. The customer count device 80 transmits customer number information to the display control device 10, including the number of customers in the commercial facility and the number of customers in a store. In addition, the customer count device 80 detects the number of visitors to each store using a camera installed in the store and a sensor installed at the doorway of the store, and transmits store visitor number information indicating the number of visitors to a store to the display control device 10.

The display control device 10 is a computer that displays and controls content to be displayed on the display device 20. For example, the display control device 10 outputs a video signal of content to the display device 20 to cause the display device 20 to display the content.

The display control device 10 includes a customer evaluation unit 101, an extraction unit 102, an advertisement data storage unit 103, a behavior detection unit 104, a customer action evaluation unit 105, a trigger determination unit 106, an inventory evaluation unit 107, a generation unit 108, an advertisement synthesizing unit 109, and a display control unit 110.

The customer evaluation unit 101 acquires a captured image from the camera 30, detects a person from the acquired captured image, and estimates attributes of the detected person to evaluate the person. The attributes of a person are, for example, age and sex.

The extraction unit 102 extracts content according to a person whose image is captured by the camera 30. Specifically, the extraction unit 102 extracts the content of an advertisement corresponding to the estimated attributes of the person from the advertisement data storage unit 103.

The extraction unit 102 may function as a determination unit that determines to cause the display device 20 to display the content according to a situation of the nearby area of which an image is captured by the camera 30. In this case, the extraction unit 102 may detect the situation of the nearby area (for example, whether there is a person) on the basis of a result of analyzing the captured image of the nearby area of the camera acquired by the camera 30.

For example, the extraction unit 102 determines to cause the display device 20 to display the content when it is detected that there is a person in the area near the display device 20. In addition, when the extraction unit 102 detects that there is no person, there is no person photographed in the area near the display device 20, and therefore the extraction unit 102 may determine not to display the content for a person.

This determination unit may be provided as a separate function from the extraction unit 102.

The advertisement data storage unit 103 stores the content of each advertisement to be displayed on the display device 20. The advertisement in the present embodiment relates to merchandise to be sold by each store of the commercial facility in which the display device 20 is installed. In addition, the advertisement data storage unit 103 stores the attributes of a person who is a target of an advertisement in association with the advertisement.

The behavior detection unit 104 detects a behavior of a person toward merchandise in a store that sells the merchandise included in the content. That is, the behavior detection unit 104 detects the behavior of a person other than a customer viewing the content displayed on the display device 20. Specifically, the behavior detection unit 104 detects the behavior of a person in a store that sells merchandise that cannot be visually recognized by a customer viewing the content displayed on the display device 20. That is, the behavior detection unit 104 detects the behavior of a person who visits the store without looking at the content displayed on the display device 20, regardless of the content. The behavior of a person is at least one of a purchase of merchandise in the store, an inquiry about merchandise, a trial use of merchandise, and the number of visitors to the store. Specifically, the behavior detection unit 104 detects the purchase of merchandise by receiving the merchandise purchase information from the POS 40. In addition, the behavior detection unit 104 detects an inquiry about merchandise by receiving the merchandise inquiry information from the barcode reader 50. In addition, the behavior detection unit 104 detects a trial use of merchandise by receiving the merchandise trial information from the RF tag reader 60. Moreover, the behavior detection unit 104 detects the number of visitors by receiving the store visitor number information from the customer count device 80.

The customer action evaluation unit 105 stores each piece of information received by the behavior detection unit 104. The customer action evaluation unit 105 accumulates information for a preset period such as a current day, the most recent week, or the most recent month. Then, the customer action evaluation unit 105 evaluates the behavior of a person toward the merchandise included in the content extracted by the extraction unit 102 on the basis of stored information. At this time, the customer action evaluation unit 105 may set a weight for each behavior when the behavior of a person is evaluated. For example, the customer action evaluation unit 105 may set a weight according to a behavior, such as giving a heavier weight to sales of merchandise and a lighter weight to inquiries about merchandise, or may also set a weight according to the number of people who have taken a behavior, such as giving a heavier weight to a behavior with a large number of people and a lighter weight to a behavior with a small number of people.

When the behavior detection unit 104 detects the behavior of a person toward merchandise included in content being reproduced during a reproduction period in which the display control unit 110 displays the content on the display device 20, the trigger determination unit 106 outputs the behavior of the person to the generation unit 108 as a trigger. The reproduction period of each content is set in advance for each content. For example, when the content is a moving image, the reproduction period is a period from a start to an end of the content.

The inventory evaluation unit 107 inquires of the inventory management system 70 about an inventory quantity of the merchandise included in the content extracted by the extraction unit 102, and receives the inventory quantity information. In addition, the inventory evaluation unit 107 inquires of the customer count device 80 about the number of customers in the commercial facility and the number of customers in the store that sells the merchandise included in the content extracted by the extraction unit 102, and receives the customer number information. Then, the inventory evaluation unit 107 evaluates an inventory status on the basis of the number of customers in the commercial facility, the number of customers in the store, and the inventory quantity of the merchandise. For example, when the number of customers in the commercial facility and the number of customers in the store are both less than a predetermined number and the inventory quantity of the merchandise has room (more than a predetermined amount), the inventory evaluation unit 107 determines that the inventory status is “many.” However, even if the inventory quantity of the merchandise has room, when the number of customers in the store is equal to or greater than the inventory quantity of the merchandise, it determines that the inventory status is “small.” When the inventory status is evaluated, the inventory evaluation unit 107 may set a weight for each evaluation item, such as giving a heavier weight to the number of customers inside the store and a lighter weight to the number of customers outside the store.

The generation unit 108 generates additional information according to the inventory status evaluated by the inventory evaluation unit 107 or the behavior of a person evaluated by the customer action evaluation unit 105. The additional information is, for example, an instigating phrase displayed on the content of the advertisement. For example, the generation unit 108 generates a phrase such as “Today, OO customers were interested in this merchandise!” according to the number of inquiries when an inquiry about merchandise is included in the behavior of a person. In other words, the additional information according to the behavior of a person is an instigating phrase that makes a guess that the merchandise will be sold out according to the behavior. The additional information may also be information suggesting that the merchandise may be purchased by a person other than a person viewing the display device according to the behavior of the person in the store. In addition, the additional information may be information that makes it possible to ascertain the inventory quantity after the merchandise is purchased according to the behavior of a person.

The generation unit 108 generates an instigating phrase that makes a guess that the merchandise will be sold out similarly for the purchase of merchandise, the trial use of merchandise, and the number of visitors to a store. In addition, the generation unit 108 generates phrases such as “only a few pieces of merchandise left” or “sufficient inventory” according to the inventory status of the merchandise included in the content. The generation unit 108 may also generate additional information according to the number of people in the commercial facility or the number of people in the store that sells the merchandise included in the content extracted by the extraction unit 102. In addition, when the behavior of a person is input as a trigger from the trigger determination unit 106 during the reproduction period of the content displayed on the display device 20, the generation unit 108 generates supplementary additional information according to the behavior of the person.

In addition, the generation unit 108 may generate additional information after the extraction unit 102 (a determination unit) has determined to cause the display device 20 to display the content. When additional information is generated after it is determined to display the content, the additional information can be generated according to the inventory status evaluated by the inventory evaluation unit 107 or the behavior of a person evaluated by the customer action evaluation unit 105 at that time.

The advertisement synthesizing unit 109 synthesizes the additional information generated by the generation unit 108 with the content extracted by the extraction unit 102. In addition, when supplementary additional information is generated during the reproduction period of content being displayed on the display device 20, the advertisement synthesizing unit 109 synthesizes the supplementary additional information with the content being reproduced.

The display control unit 110 causes the display device 20 to display the content extracted by the extraction unit 102 and the additional information generated by the generation unit 108. For example, the display control unit 110 causes the display device 20 to display the content synthesized with additional information corresponding to the behavior of a person detected before the display of the content. In addition, when the behavior of a person toward merchandise in a store that sells the merchandise included in the content is detected during the reproduction period of the content displayed on the display device 20, the display control unit 110 adds supplementary additional information according to the behavior to the display. Specifically, the display control unit 110 adds and displays the synthesized supplementary additional information during a reproduction of the content.

Since the display control unit 110 causes the display device 20 installed outside a merchandise display area to display the content extracted by the extraction unit 102 and the additional information generated by the generation unit 108, it is possible to inform a person outside the merchandise display area that merchandise may be purchased by a customer within the merchandise display area on the basis of the behavior of the customer and the like in the merchandise display area.

Next, an operation of this content display system 1 will be described.

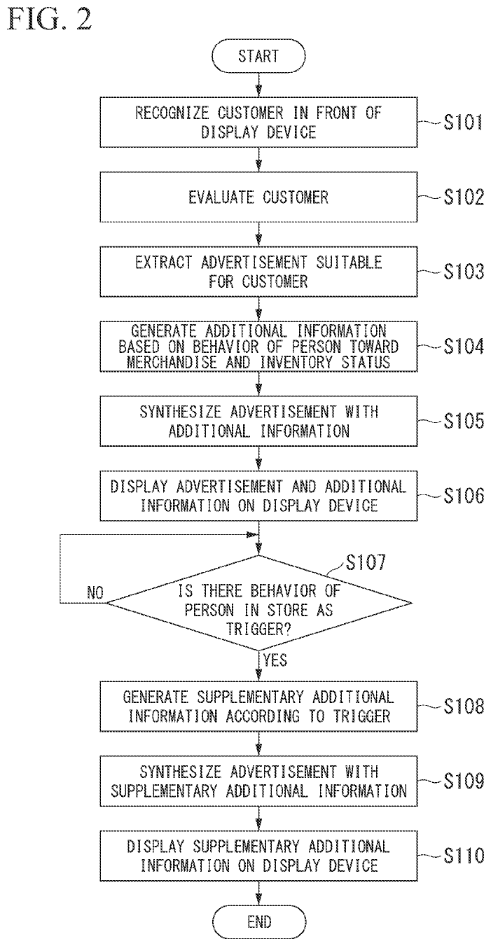

FIG. 2 is a flowchart which describes an operation of content display processing executed by the content display system.

When the display control device 10 recognizes a customer in front of a display screen of the display device 20 (step S101), it executes processing shown in FIG. 2. For example, when the customer evaluation unit 101 detects a person from the captured image acquired from the camera 30, the display control device 10 recognizes that a customer is in front of the display screen.

The customer evaluation unit 101 of the display control device 10 estimates attributes of the recognized customer and evaluates the recognized customer (step S102). Subsequently, the extraction unit 102 extracts content of an advertisement suitable for the recognized customer on the basis of the evaluation (step S103).

The customer action evaluation unit 105 evaluates the behavior of a person in a store toward the merchandise included in the content of the extracted advertisement on the basis of the stored information. In addition, the inventory evaluation unit 107 evaluates the inventory status of the merchandise included in the content of the extracted advertisement. Then, the generation unit 108 generates additional information based on the behavior of the person in the store and the inventory status (step S104). Subsequently, the advertisement synthesizing unit 109 synthesizes the content of the extracted advertisement with the generated additional information (step S105). After that, the display control unit 110 causes the display device 20 to display the content of the advertisement synthesized with the additional information (step S106).

The trigger determination unit 106 determines whether the behavior of the person in the store toward the merchandise included in the content being reproduced has been detected during the reproduction period of the content of the advertisement being displayed on the display device 20 (step S107). When the behavior of the person is not detected (No in step S107), the trigger determination unit 106 executes processing of step S107 again. On the other hand, when the trigger determination unit 106 has detected the behavior of the person during the reproduction period (Yes in step S107), it determines the behavior as a trigger. The generation unit 108 generates supplementary additional information on the basis of the behavior of the person indicated by the trigger (step S108). The advertisement synthesizing unit 109 synthesizes the supplementary additional information with the content of the advertisement being reproduced (step S109). The display control unit 110 displays the content of the advertisement synthesized with the supplementary additional information on the display device 20 (step S110). After that, the processing ends.

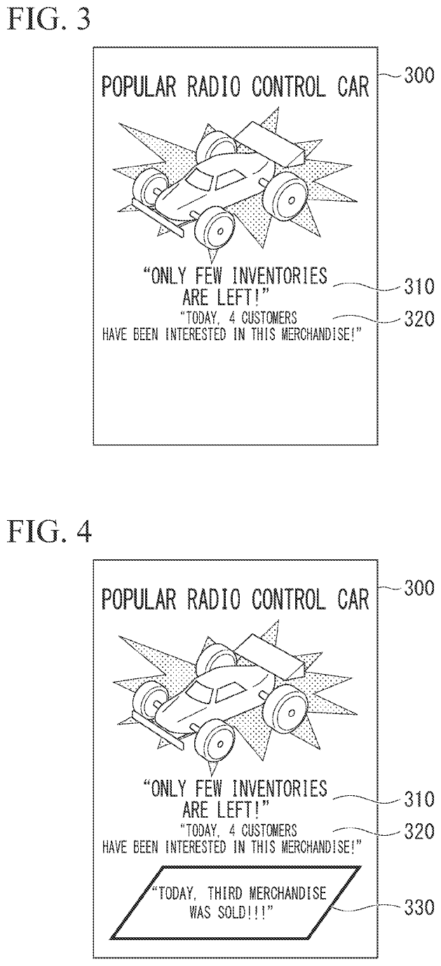

FIG. 3 is an image diagram which shows an example of an advertisement displayed by the display device.

As shown in FIG. 3, the display control unit 110 synthesizes, in the content 300 of the advertisement, additional information “only a few inventories are left!” 310 according to the inventory status of the merchandise included in the content 300 with additional information “Today, 4 customers have been interested in this merchandise!” 320 according to the behavior of a person toward the merchandise in a store that sells the merchandise included in the content 300 (an inquiry about the merchandise in an example shown in FIG. 3), and displays a synthesized result on the display device 20. The additional information 320 is information according to the behavior of a person before the content 300 is displayed.

FIG. 4 is an image diagram which shows a display example in which supplementary additional information is added to the advertisement displayed on the display device.

FIG. 4 shows a display example when the behavior of a person toward the merchandise included in the content 300 in the store that sells the merchandise is detected as a trigger during the reproduction period of the content 300.

As shown in FIG. 4, when the display control unit 110 detects the behavior of a person as a trigger during the reproduction period of the content 300, supplementary additional information “Today, the third merchandise was sold!!!” 330 according to the behavior of a person (In the example shown in FIG. 4, the purchase of the merchandise) shown by the trigger is added to the content 300 of the advertisement shown in FIG. 3.

In this manner, the content display system 1 according to the present embodiment includes the display device 20 installed in a place different from the merchandise display area, a behavior detection unit 104 that detects the behavior of a person toward merchandise in a store that sells the merchandise included in the content, a generation unit 108 that generates additional information according to the behavior of a person, and a display control unit 110 that causes the display device 20 to display the content and additional information.

With such a configuration, additional information according to the behavior of a person in a store toward the merchandise included in the content of the advertisement is displayed on the display device 20 along with the content. As a result, it is possible to cause a customer who has viewed the content to guess that the merchandise being advertised will be sold out according to the behavior of a person in the store, and to stimulate the purchase desire of the customer by making him or her impatient with it.

In addition, the behavior of a person detected by the behavior detection unit 104 is at least one of a purchase of merchandise in the store, an inquiry about merchandise, a trial use of merchandise, and the number of visitors to the store. As a result, the content display system 1 can appeal the popularity of merchandise according to these behaviors of a person and urge purchase desires of customers.

In addition, when the behavior of a person toward merchandise in the store that sells the merchandise included in the content is detected during the reproduction period of the content, the display control unit 110 adds additional information corresponding to the behavior to the display. As a result, the content display system 1 can perform the display that has reflected the behavior of a person in the store toward the merchandise being advertised in real time.

In addition, the display control unit 110 displays additional information and content according to the behavior detected before the content is displayed. As a result, the content display system 1 can display the additional information that has reflected the behavior of a person toward the merchandise detected before the content is displayed, along with the content.

Moreover, the generation unit 108 generates additional information according to the inventory status of the merchandise included in the content. As a result, customers who have viewed the content can ascertain the inventory status of the merchandise. For example, when an inventory level of the merchandise is low, it is possible to make the customers impatient and to urge their purchase desire for the merchandise by predicting that the merchandise will be sold out.

In addition, the generation unit 108 generates additional information according to the number of people in the commercial facility having a store that sells merchandise included in the content or the number of people in the store that sells the merchandise included in the content. As a result, customers who have viewed the content can guess how many competitors who purchase the merchandise are present. For example, when the number of people in the store is large, it is possible to make the customers impatient that the merchandise will be sold out unless they buy it soon, and to urge their purchase desire for the merchandise.

In addition, the display device 20 is installed outside the store that sells the merchandise included in the content, and the behavior detection unit 104 detects the behavior of a person inside the store that sells the merchandise included in the content. As a result, a customer outside the store can understand the behavior of another person inside the store toward the merchandise being advertised.

In addition, the content display system 1 has the camera 30 that captures an area near the display device 20, and the extraction unit 102 that extracts content corresponding to a person whose image is captured by the camera 30. The display control unit 110 causes the display device 20 to display the extracted content and the additional information. As a result, the content display system 1 can display content of an advertisement suitable for a customer in front of the display device 20, thereby attracting the customer's interest.

Moreover, the additional information makes it possible to guess sold-out of merchandise according to the behavior of a person toward the merchandise. As a result, it is possible to make customers who have viewed the content impatient by causing them to guess that the merchandise will be sold out and to urge the purchase desire of the customers.

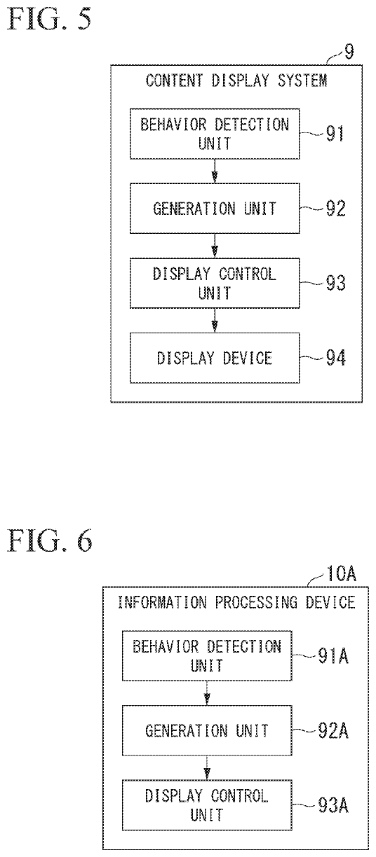

FIG. 5 is a diagram which shows a configuration of the content display system in another embodiment.

The content display system 9 includes a behavior detection unit 91, a generation unit 92, a display control unit 93, and a display device 94.

The behavior detection unit 91 detects the behavior of a person toward merchandise in a merchandise display area where the merchandise included in the content is displayed.

The generation unit 92 generates additional information according to the detected behavior of the person.

The display control unit 93 causes the display device 94 to display content and additional information.

The display device 94 is installed in a place different from the merchandise display area.

FIG. 6 is a diagram which shows a configuration of an information processing device in another embodiment.

The information processing device 10A can be communicatively connected to a display device installed at a location different from the merchandise display area.

The information processing device 10A includes a behavior detection unit 91A, a generation unit 92A, and a display control unit 93A.

The behavior detection unit 91A detects a behavior of a person toward the merchandise in the merchandise display area where the merchandise included in the content is displayed.

The generation unit 92A generates additional information according to the behavior of a person.

The display control unit 93A causes an externally connected display device to display content and additional information.

Such an information processing device 10A may be, for example, a computer.

In addition, position detection may be performed by recording a program for realizing each function of the display control device 10 of FIG. 1 and the information processing device 10A of FIG. 6 in a computer-readable recording medium and causing a computer system to read and execute the program recorded in this recording medium. A term “computer system” used herein includes an OS and hardware such as peripheral devices.

In addition, the “computer system” includes a homepage provision environment (or a display environment) if a WWW system is used.

In addition, the “computer-readable recording medium” refers to a portable medium such as a flexible disk, a magneto-optical disc, a ROM, or a CD-ROM, or a storage device such as a hard disk embedded in a computer system. Furthermore, it is assumed that the “computer-readable recording medium” includes those that hold a program for a certain period of time, such as a volatile memory inside the computer system that serves as a server or client. Moreover, the program described above may be a program for realizing a part of the functions described above, or may be a program capable of further realizing the functions described above in combination with a program already recorded in the computer system. In addition, the program described above may be stored in a predetermined server, and may also be distributed (downloaded, or the like) via a communication line in response to a request from another device.

Although the embodiment of the present invention has been described in detail with reference to the drawings, a specific configuration is not limited to this embodiment, and includes designs within a range not departing from the gist of the present invention.

### REFERENCE SIGNS LIST

1, 9 Content display system
10 Display control device
101 Customer evaluation unit
102 Extraction unit
103 Advertisement data storage unit
104, 91 Behavior detection unit
105 Customer action evaluation unit
106 Trigger determination unit
107 Inventory evaluation unit
108, 92 Generation unit
109 Advertisement synthesizing unit
110, 93 Display control unit
20, 94 Display device
30 Camera
40 POS
50 Barcode reader
60 RF tag reader
70 Inventory management system
80 Customer count device

What is claimed is:

1. An information processing device that is communicatively connected to a display device installed in a location different from a merchandise display area, the information processing device comprising:
a behavior detection unit configured to detect a behavior of a person with respect to merchandise included in content in the merchandise display area where the merchandise is displayed;
a generation unit configured to generate additional information according to the behavior of the person; and
a display control unit configured to cause the display device to display the content and the additional information.

2. The information processing device according to claim 1, further comprising:
a determination unit configured to determine to cause the display device to display the content according to an analysis result of an image acquired by a camera that captures an image of an area near the display device,
wherein the generation unit generates the additional information after the determination unit determines to cause the display device to display the content.

3. The information processing device according to claim 1,
wherein the behavior is at least one of a purchase of merchandise in a store, an inquiry about merchandise, a trial of merchandise, and a number of visitors.

4. The information processing device according to claim 1,
wherein, when a behavior of a person with respect to merchandise in a store that sells the merchandise included in the content is detected during a reproduction period of the content, the display control unit adds and displays additional information according to the behavior.

5. The information processing device according to claim 1,
wherein the display control unit displays the additional information according to the behavior detected before a display of the content and the content.

6. The information processing device according to claim 1,
wherein the generation unit generates additional information according to an inventory status of merchandise included in the content.

7. The information processing device according to claim 1,
wherein the generation unit generates additional information according to the number of people in a commercial facility having a store or the number of people in the store.

8. The information processing device according to claim 1,
wherein the display device is installed outside a store, and
the behavior detection unit detects a behavior of a person in the store.

9. The information processing device according to claim 1,
wherein the additional information is information suggesting that the merchandise is purchasable by a person other than a person who views the display device according to the behavior.

10. The information processing device according to claim 1,
wherein the additional information is information for ascertaining an inventory quantity after the merchandise is purchased according to the behavior.

11. A content display system comprising:
a display device installed in a location different from a merchandise display area;
a behavior detection unit configured to detect a behavior of a person with respect to merchandise in content in the merchandise display area where the merchandise is displayed;
a generation unit configured to generate additional information according to the behavior of the person; and
a display control unit configured to cause the display device to display the content and the additional information.

12. The content display system according to claim 11, further comprising:
a camera configured to capture an image of an area near the display device; and
a determination unit configured to determine to cause the display device to display the content according to a situation of the area near the display device of which the image is captured by the camera,
wherein the generation unit generates the additional information after the determination unit determines to cause the display device to display the content.

13. An information processing method comprising:
detecting a behavior of a person with respect to merchandise included in content in a merchandise display area where the merchandise is displayed;
generating additional information according to the behavior of the person; and
causing the display device installed in a location different from the merchandise display area to display the content and the additional information.
